(19) United States
(12) Patent Application Publication
(10) Pub. No.: US 2015/0255005 A1
(43) Pub. Date: Sep. 10, 2015

(54) MOVEMENT EVALUATION DEVICE AND PROGRAM THEREFOR

(71) Applicants: NATIONAL INSTITUTE OF ADVANCED INDUSTRIAL SCIENCE AND TECHNOLOGY, Tokyo (JP); TOKYO MEDICAL UNIVERSITY, Tokyo (JP)

(72) Inventors: Ikushi Yoda, Tsukuba-shi (JP); Masaki Onishi, Tsukuba-shi (JP); Tetsuo Yukioka, Shinjuku-ku (JP); Shoichi Ohta, Shinjuku-ku (JP); Shiro Mishima, Shinjuku-ku (JP); Jun Oda, Shinjuku-ku (JP)

(21) Appl. No.: 14/427,801

(22) PCT Filed: Sep. 9, 2013
(86) PCT No.: PCT/JP2013/074227

§ 371 Date: Mar. 12, 2015

(30) Foreign Application Priority Data
Sep. 12, 2012 (JP) 2012-200433

(51) Int. Cl. G09B 23/28; G09B 19/00; G06F 17/10

(52) U.S. Cl. CPC G09B 23/288; G06F 17/10; G09B 19/003

(57) ABSTRACT

To provide an action exhibiting apparatus capable of effectively exhibiting an exemplary action to a user.

An action evaluating apparatus according to the present invention includes a part coordinate calculating section that calculates a part coordinate of a body of a user based on image data on the user, a user model generating section that generates a geometric model of the user based on the part coordinate and generates moving image data on an instructor action represented by the geometric model of the user based on an instructor action parameter, an action evaluating section that evaluates an action of the user based on the part coordinate, and an output controlling section that displays the instructor action represented by the geometric model of the user and the action of the user in a superimposed manner and outputs an evaluation result.

### TECHNICAL FIELD

The present invention relates to an action evaluating apparatus that assists a user to learn an action of an emergency medical treatment including an especially chest compression action (so-called cardiac massage), caregiving or sports, etc. by exhibiting an exemplary action to the user and evaluating the action of the user, and a program therefor.

### BACKGROUND ART

Various action exhibiting apparatuses that exhibit an action to a user have been studied. For example, in training of the chest compression action, a cardiopulmonary resuscitation doll incorporating a sensor is put on the floor, and a user performs the chest compression action on the doll. The depth of the chest compression on the doll is measured by the sensor to determine whether the action is proper or not. However, measuring the depth of the chest compression is not enough to determine whether the chest compression is being properly performed. To properly perform the chest compression action, a proper posture, a proper elbow angle, and an appropriate compression cycle are needed. In the conventional training using a cardiopulmonary resuscitation doll, there is a problem that the posture or the like of the user cannot be evaluated, and the proper action cannot be exhibited.

According to the technique disclosed in Patent Literature 1, a robot exhibits an action. When a user perform an action, the action of the user is imaged, the difference between the imaged action of the user and the action exhibited by the robot is determined based on the image, and an advice to compensate for the difference is provided.

According to the technique disclosed in Patent Literature 2, an appropriate instructor image can be provided to a user by detecting the line of sight of the user and providing an image of an instructor viewed from the angle of the user.

### CITATION LIST

### Patent Literatures

### Patent Literature 1: Unexamined Japanese Patent Publication No. 2006-320424

Patent Literature 2: Unexamined Japanese Patent Publication No. Hei11-249772

### SUMMARY OF INVENTION

### Technical Problem

However, the techniques disclosed in Patent Literatures 1 and 2 have a problem that a slight difference between the action exhibited by the robot and the action of the user, or an appropriate pace of the action cannot be exhibited. In addition, the instructor images provided in these techniques do not reflect the build of the body of the user, so that it is difficult for the user to grasp the difference of action, and the user cannot satisfactorily learn the action.

The present invention has been devised in view of the problems of prior art described above, and an object of the present invention is to provide an action exhibiting apparatus capable of effectively exhibiting an exemplary action to a user by providing an instructor action image represented by a model that reflects the build of the body of a user, displaying the instructor action image and an image of the action of the user in an superimposed manner, and evaluating the action of the user.

### Solution to Problem

In order to attain the object described above, the present invention provides an action evaluating apparatus comprising a part coordinate calculating section that calculates a part coordinate of a body of a user based on image data on the user, a user model generating section that generates a geometric model of the user based on the part coordinate and generates moving image data on an instructor action represented by the geometric model of the user based on an instructor action parameter, an action evaluating section that evaluates an action of the user based on the part coordinate, and an output controlling section that displays the instructor action represented by the geometric model of the user and the action of the user in a superimposed manner and outputs an evaluation result.

Furthermore, the part coordinate calculating section according to the present invention is characterized by calculating a part coordinate of each of parts of the body of the user including the head, the shoulders, the elbows, the hands and the wrists by calculating a coordinate of the center of gravity of the part. Furthermore, the part coordinate calculating section may calculate the part coordinate of each part based on at least parallax information for a pixel in a predetermined region of the part. Furthermore, the part coordinate calculating section may calculate part coordinates of the shoulders and calculates a part coordinate of the head based on the part coordinates of the shoulders.

Furthermore, the user model generating part is characterized by having a build data calculating section that generates build data of the user based on the part coordinates calculated by the part coordinate calculating section, and an instructor action adding section that generates instructor moving image data represented by the geometric model of the user by adding an instructor action parameter to the build data for the user at each point in time.

Furthermore, the instructor action adding section is characterized by correcting the part coordinates of the elbows and the shoulders of the build data acquired from the build data calculating section based on the part coordinates of the wrists and an initial angle involved with the instructor action.

Furthermore, the action evaluating section is characterized by extracting one cycle of action of the user for evaluation, and the output controlling section is characterized by outputting an evaluation result.

The action referred to in the present invention is a chest compression action, and the action evaluating apparatus can evaluate the chest compression action of the user.

Furthermore, the present invention provides a program that makes a computer function as an action evaluating apparatus that comprises a part coordinate calculating section that calculates a part coordinate of a body of a user based on image data on the user, a user model generating section that generates a geometric model of the user based on the part coordinate and generates moving image data on an instructor action represented by the geometric model of the user based on an instructor action parameter, an action evaluating section that evaluates an action of the user based on the part coordinate, and an output controlling section that displays the instructor action represented by the geometric model of the user and the action of the user in a superimposed manner and outputs an evaluation result.

### Advantageous effects of Invention

According to the present invention, a geometric model that reflects the build of the body of a user can be generated, and an instructor action represented by the model can be displayed. As a result, the user can more easily grasp the proper action and more quickly learn the proper action. Furthermore, since an instructor image is provided as a three-dimensional geometric model, the user can clearly grasp any difference in posture in the depth direction, which is difficult to grasp according to prior art, can be clearly grasped, and more accurately learn the action.

Furthermore, according to the present invention, the instructor image and the image of the user performing the action are displayed in a superimposed manner, and an evaluation result is displayed. As a result, the user can clearly grasp any slight difference from the instructor action. Therefore, the user can quickly learn the proper action.

### BRIEF DESCRIPTION OF DRAWINGS

FIG. 1 is a block diagram showing an example of an overall configuration of an action evaluating apparatus 100 according to the present invention.

FIG. 2 is a flowchart showing an example of a flow of a processing of calculating a part coordinate of each part of the body of a user performed by the action evaluating apparatus 100.

FIG. 3 is a diagram showing an example of a coordinate range specified as a part coordinate calculation range.

FIG. 4 is a diagram for illustrating a method of calculating the center of gravity of the right elbow, in which squares are conceptual representations of pixels parallax and color information on which fall within a parameter range.

FIG. 5a is a diagram for illustrating a region to be extracted as the head.

FIG. 5b is a schematic diagram showing pixels used for calculation of the center of gravity of the head and a calculated center of gravity.

FIG. 6 is a functional block diagram showing an example of a configuration of a user model generating section 104.

FIG. 7a is a flowchart showing a processing of generating an instructor action parameter based on an instructor moving image.

FIG. 7b is a flowchart showing a processing of generating a moving image of an instructor action represented by a geometric model of the user.

FIG. 8 is a schematic diagram for illustrating correction of build data for the user.

FIG. 9 is a flowchart showing a processing of evaluating an action of the user.

FIG. 10 shows an example of a superimposed display of a geometric model image that reflects the build of the user and an image of the user.

FIG. 11 is a graph showing a transition of a part coordinate of the hands of the user.

FIG. 12 is a table showing differences between pieces of image data and the direction of movement of compression.

FIG. 13 is an example of a table showing one cycle of chest compression action detected based on the transition of the part coordinate of the hands of the user.

FIG. 14 is an example of an evaluation table that contains feature quantities and thresholds thereof.

FIG. 15 shows an example of a superimposed display of the geometric model of the user performing the instructor action and the chest compression action of the user in which an advice is further displayed on the screen.

FIG. 16 is a diagram showing an example of a hardware configuration of the action evaluating apparatus.

### DESCRIPTION OF EMBODIMENTS

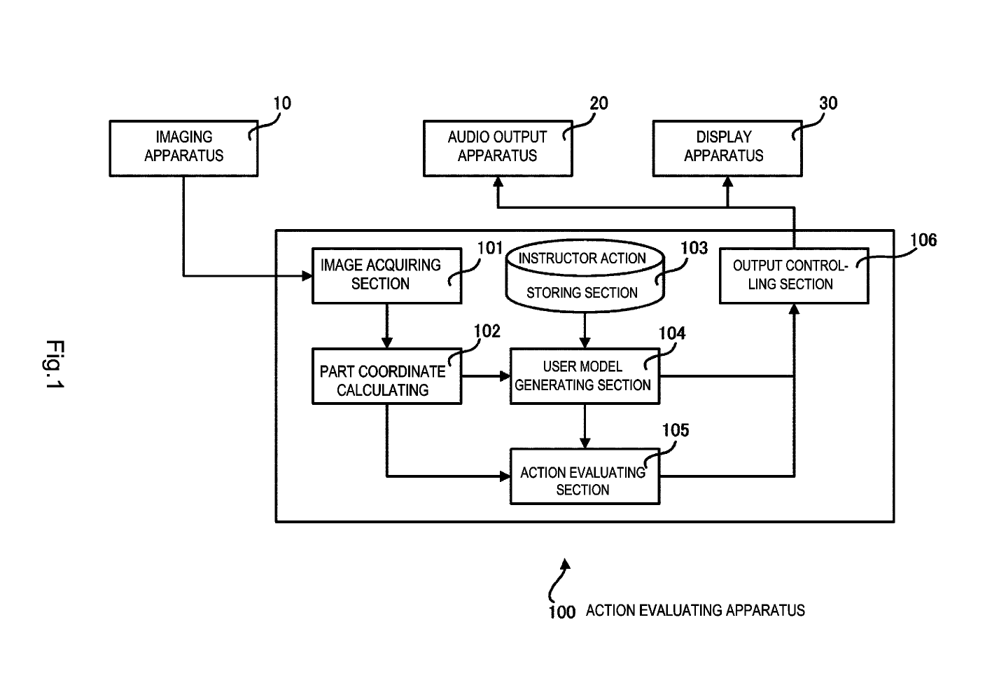

FIG. 1 is a block diagram showing an example of an overall configuration of an action evaluating apparatus 100 according to the present invention. In FIG. 1, the action evaluating apparatus 100 is connected to an imaging apparatus 10, an audio output apparatus 20, and a display apparatus 30. The imaging apparatus 10 is a so-called stereo camera that has two cameras, for example. The imaging apparatus 10 may be a camera capable of capturing a three-dimensional range image. For example, the imaging apparatus 10 images a user performing an action to be learned, such as a chest compression action. The imaging apparatus 10 obtains a time series of image data by imaging, and transmits the image data to the action evaluating apparatus 100. The audio output apparatus 20 is a speaker, for example, and acoustically outputs an instruction to the user or an evaluation result or an advice from the action evaluating apparatus 100. The display apparatus 30 is a display, for example, and displays moving image data obtained by the imaging apparatus 10. The display apparatus 30 further displays the result of evaluation of the action of the user and displays an instructor action represented by a generated geometric model of the user and imaging data in a superimposed manner.

The action evaluating apparatus 100 has an image acquiring section 101, a part coordinate calculating section 102, an instructor action storing section 103, a user model generating section 104, an action evaluating section 105, and an output controlling section 106.

The image acquiring section 101 acquires a moving image of a user action input in real time from the imaging apparatus 10 or moving image data stored in a database or the like (not shown). The acquired moving image data is moving image data containing parallax data or range data.

The part coordinate calculating section 102 calculates a part coordinate of each part of the body of the user for each piece of one-frame image data of the moving image data acquired by the image acquiring section 101. The “part of the body” refers to a part of the human body, such as the head or a shoulder. The part coordinate calculating section 102 detects each part of the body of the user based on the parallax or color information of the acquired image, and calculates the center of gravity of the part, thereby calculating the part coordinate of the part of the body of the user in the image. A specific calculation method will be described later. The calculated part coordinate is output to the user model generating section 104 or the action evaluating section 105.

The instructor action storing section 103 is a memory having a database, for example, and stores moving image data of a moving image of an exemplary instructor action. When a chest compression action is to be instructed, the instructor action storing section 103 stores moving image data on a moving image of a chest compression action of an emergency medical technician, for example. The moving image data stored in the instructor action storing section 103 contains parallax data or range data. As described later, if no instructor action parameter generating section 601 is provided, the instructor action storing section 103 stores an instructor action parameter, which is data on a time-series variation of the part coordinate of each part.

The user model generating section 104 generates a three-dimensional geometric model of the user and generates moving image data on an instructor action represented by the geometric model of the user. That is, based on the part coordinate of each part of the body of the user calculated from the frame image data by the part coordinate calculating section 102, the user model generating section 104 generates a geometric model of the user. If the instructor action storing section 103 stores the instructor moving image data, the user model generating section 104 generates an instructor action parameter based on the instructor moving image data. If the instructor action storing section 103 stores an instructor action parameter, the user model generating section 104 reads the instructor action parameter. The user model generating section 104 generates the instructor action represented by the geometric model of the user by adding the instructor action parameter to the geometric model of the user.

The action evaluating section 105 evaluates the action of the user based on the instructor action represented by the geometric model of the user. The action of the user is analyzed by calculating a time-series variation of the image acquired by the image acquiring section 101 or a time-series variation of the part coordinate during the action calculated by the part coordinate calculating section 102. The action evaluating section 105 evaluates the action of the user by providing an evaluation table for the time-series variation, which stores a threshold for a predetermined part set based on the instructor action, and making a comparison with the threshold. Alternatively, the action evaluating section 105 may evaluate the action of the user by making a comparison with the moving image data on the instructor action represented by the geometric model that reflects the build of the body of the user generated by the user model generating section 104. Alternatively, the action evaluating section 105 may not only perform the evaluation of the action of the user but also select and output an advice about an improvement to bring the user action closer to an ideal one.

The output controlling section 106 controls output to the display apparatus 30 and the audio output apparatus 20. The output controlling section 106 controls the output so as to display the moving image of the action of the user acquired by the image acquiring section 101 from the imaging apparatus 10 and the moving image of the instructor action represented by the geometric model that reflects the build of the body of the user generated by the user model generating section 104 in a superimposed manner. The output controlling section 106 controls the output so as to display or acoustically output the evaluation result or an advice from the action evaluating section 105.

A process performed by the action evaluating apparatus according to the present invention is generally separated into the following three processings: (1) a processing of calculating the part coordinate of each part of the body of a user; (2) a processing of generating an instructor action represented by a geometric model of the user; and (3) a processing of displaying the action of the user and the instructor action in a superimposed manner and evaluating the action of the user. The action evaluating apparatus performs the part coordinate calculation processing (1) on a moving image of the user input from the imaging apparatus 10 on a frame image data basis. Before the user starts the action, the action evaluating apparatus instructs the user to remain at rest to allow the action evaluating apparatus to generate a geometric model of the user, and then performs the processing (2) of generating the instructor action represented by the geometric model of the user (a user geometric model generation mode) based on the result of the part coordinate calculation processing (1). Once the processing (2) is completed, the action evaluating apparatus enters an action evaluation mode, and proceeds to the evaluation processing (3) based on the result of the part coordinate calculation processing (1). That is, the processing (1) is performed on the moving image data before any of the processings (2) and (3). In the following, these processings will be specifically described.

(1) Processing of Calculating Part Coordinate of Each part of Body of User

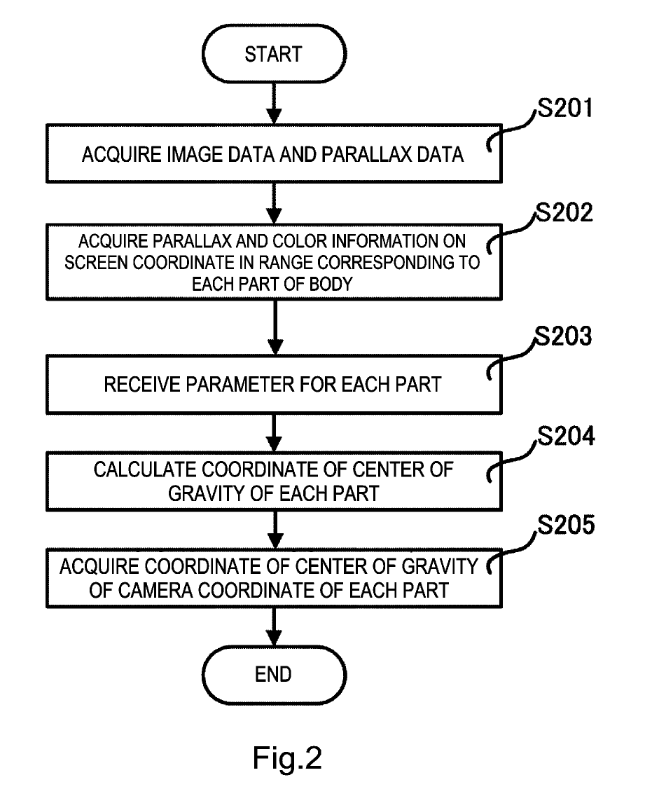

FIG. 2 is a flowchart showing an example of a flow of the processing of calculating the part coordinate of each part of the body of a user performed by the action evaluating apparatus 100. The following description will be made in the context of instructing the chest compression action.

The image acquiring section 101 acquires range image data input from the imaging apparatus, that is, image data and parallax data (Step S201). The image acquiring section 101 may acquire two pieces of image data from a stereo camera and calculate the parallax from the image data. Although the image acquiring section 101 has been described as acquiring image data and parallax data, the image acquiring section 101 may acquire image data and range data if the imaging apparatus is not a stereo camera but a camera incorporating a range finder. The “image data” referred to herein is image data (one-frame image) at each of different points in time of moving image data, which is a time-series image. The part coordinate calculation processing is performed for each piece of acquired image data. The image acquiring section 101 outputs the input image data and parallax data to the part coordinate calculating section 102.

The part coordinate calculating section 102 acquires parallax and color information for each pixel in a screen coordinate system in an area corresponding to each part of the body of the user from the image data acquired by the image acquiring section 101 (Step S202). The part coordinate calculating section 102 performs the part coordinate calculation processing for each part of the body of the user. The parts include the head, the shoulders (right shoulder and left shoulder), the elbows (right elbow and left elbow), the hands, and the wrists (left wrist and right wrist). To simplify the part coordinate calculation, the user may wear markers of a particular color at predetermined positions, such as the shoulders, the elbows and the wrists. The part at which the marker is attached to the body of the user is determined in advance. For example, a marker for a shoulder is wound around the shoulder from the axilla, and a marker for an elbow is attached to the bottom of the brachium close to the elbow. The user is positioned at a predetermined distance in front of the imaging apparatus so that the user has a predetermined size in the image. The part coordinate calculating section 102 stores a coordinate range (x and y coordinates in a screen coordinate system) as a part coordinate calculation range in the image data in which the parts of the body can be located, and acquires parallax and color information (such as hue, chroma or lightness) on the range in the screen coordinate system for the part coordinate calculation.

The part coordinate calculating section 102 receives a parameter for each part of the body of the user (Step S203). The parameter is a threshold concerning the parallax and color information, and a different parameter is set for a different part of the body of the user. For example, parameters for the right elbow include a parallax of 155 to 255, a hue of 79 to 89, a chroma of 150 to 200, and a lightness of 0 to 19. The color information is represented by a value ranging from 0 to 255, for example. If markers are attached to the shoulders, the elbows and the wrists, the parameters are set taking the colors of the markers into consideration. The parameters for the hands are set taking the skin color of the hands into consideration. In the chest compression action, the hands are put together and therefore detected as one. The parameters for the hands are stored in the part coordinate calculating section 102 in advance. Alternatively, the parameters may be input from an external storage device. The part coordinate calculating section 102 extracts pixels in the coordinate range corresponding to each part, and makes a comparison for each pixel to determine whether the parallax and color information have values in the respective ranges specified by the parameters. The section 102 extracts pixels at which all of the parallax and color information have values in the respective ranges specified by the parameters, and acquires coordinate values of the pixels.

The part coordinate calculating section 102 then calculates a coordinate of the center of gravity of each part (Step S204). The part coordinate calculating section 102 calculates, as the coordinate of the center of gravity, an average of the coordinates of the pixels whose parallax and color information have values falling within the respective predetermined ranges extracted in Step S203, and uses the calculated average as the part coordinate data. In principle, the coordinates of the centers of gravity can be calculated in any order. However, the coordinates of the centers of gravity of the head and the hands can be more precisely calculated by using the result of calculation of the centers of gravity of the shoulders and the wrists.

For example, in calculation of the coordinate of the center of gravity of a hand, the coordinate range stored in advance as an extraction range is modified with the calculated coordinate of the center of gravity of the wrist. More specifically, in the screen coordinate system whose x axis extends in a horizontal direction and whose y axis extends in the vertical direction, the maximum value of the y coordinates in the coordinate range for the hand is extracted after being modified with the y coordinate of the center of gravity of the wrist. Similarly, the extraction range for the head is modified with the y coordinates of the centers of gravity of the shoulders.

The coordinate of the center of gravity of the head can be unable to be properly calculated due to no parallax in the center part thereof. Therefore, the coordinate of the center of gravity of the head is calculated after the region of the coordinate values used for the calculation is further corrected. A method of calculating the coordinate of the center of gravity of the head will be described later.

The part coordinate calculating section 102 acquires the coordinate of the center of gravity of each part in a camera coordinate system (Step S205). The coordinate value calculated in Step S204 is a value in the screen coordinate system and therefore needs to be converted into a value in the camera coordinate system. Supposing that the position of the camera is an origin, a plane parallel to the camera plane is an X-Y plane, and an optical axis extending from the camera plane is a Z axis, a position (camera coordinate) in a three-dimensional space can be calculated according to the following formula, for example.

$$( {x}_{R} , {y}_{R} ) , ( {x}_{L} , {y}_{L} ) \text{:} pixels of left and right images \\ b \text{:} base line ( distance between left and right cameras ) \\ f \text{:} depth of focus \\ d \text{:} parallas ( {x}_{R} - {x}_{L} ) \\ X = \frac{b ( {x}_{R} + {y}_{R} )}{2 d} \\ Y = \frac{b}{d} {y}_{R} \\ Z = \frac{bf}{d} \qquad [ Expression 1 ]$$

The part coordinate calculating section 102 calculates the part coordinate in the camera coordinate system for each part of the body of the user, and outputs the part coordinates to the user model generating section 104 or the action evaluating section 105.

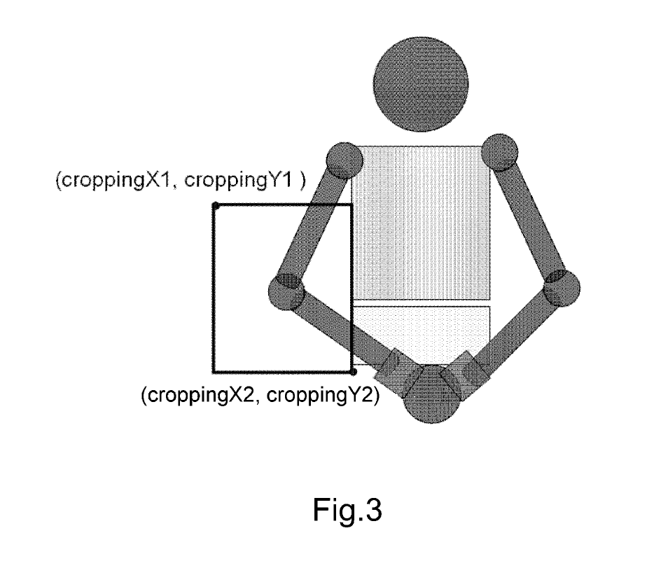

FIG. 3 is a diagram showing an example of the coordinate range specified as the part coordinate calculation range. For example, the part coordinate calculating section 102 stores two coordinate values (X1, Y1) and (X2, Y2) as the range in the image data in which the right elbow can be located. Specifically, these coordinate values represent the maximum values and the minimum values of the x coordinate and the y coordinate. Once the part coordinate calculating section 102 acquires image data, the part coordinate calculating section 102 extracts a rectangle defined by these two coordinate values, that is, (X1, Y1), (X1, Y2), (X2, Y1) and (X2, Y2), as the part coordinate calculation range. Similarly, the part coordinate calculating section 102 stores a coordinate range corresponding to each of the other parts. Based on the stored coordinate range, the part coordinate calculating section 102 acquires the parallax and color information for a pixel in the relevant range from the image data.

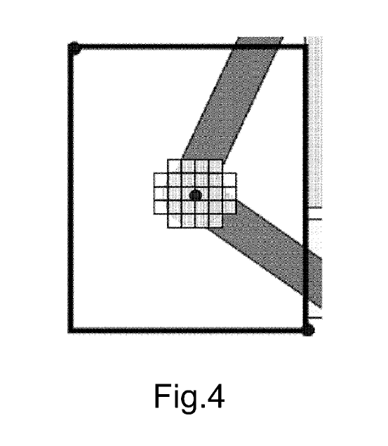

FIG. 4 is a diagram for illustrating a method of calculating the center of gravity of the right elbow. Each square is a conceptual representation of a pixel the parallax and color information on which fall within the range specified by the parameter. The part coordinate calculating section 102 extracts these pixels that fall within the respective parameter ranges, calculates the average value of the coordinates thereof as the center of gravity, and designates the coordinate of the center of gravity as the coordinate of the part. The black dot in FIG. 4 represents the calculated position of the center of gravity of the right elbow.

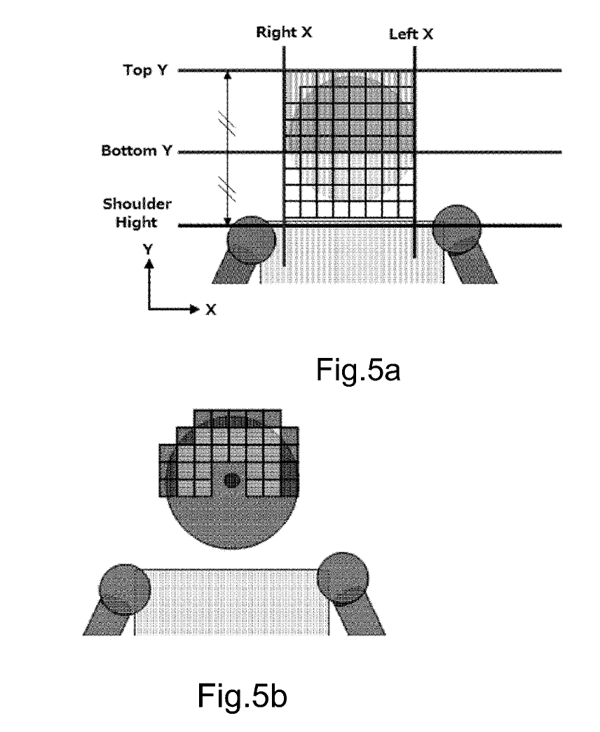

FIGS. 5 are diagrams for illustrating a method of calculating the coordinate of the center of gravity of the head. FIG. 5a is a diagram for illustrating a region to be extracted as the head. Supposing that the image data and the parallax data are acquired as in the calculation of the center of gravities of the other parts, a method of calculating the part coordinate of the head will be now described. When calculating the coordinate of the center of gravity of the head, the part coordinate calculating section 102 reads the stored coordinate range for the head. In addition, the part coordinate calculating section 102 acquires the y coordinates of the calculated centers of gravity of the left and right shoulders, calculates an average value thereof, and modifies the minimum value of the y coordinate of the coordinate range for the head to the average value of the y coordinates of the shoulders. The part coordinate calculating section 102 then acquires parallax and color information in the screen coordinate system based on the modified coordinate range. This is the processing of Step S202. The part coordinate calculating section 102 then receives parameters for the head. This is the processing of Step S203. As a parameter for the head, a parallax threshold is stored. The part coordinate calculating section 102 extracts a pixel having a relevant parallax value.

The part coordinate calculating section 102 acquires a maximum value (LeftX) and a minimum value (RightX) of the x coordinate and a maximum value (TopY) of the y coordinate from the coordinate values of the extracted pixel. The part coordinate calculating section 102 calculates a coordinate value (BottomY) of the y coordinate that is at the midpoint between the maximum value (TopY) of the y coordinate and the average value (Shoulder Height) of the y coordinates of the centers of gravity of the shoulders. Of the pixels extracted based on the parallax value, the pixels in the region defined by the points LeftX, RightX, TopY and BottomY are modified for use for the center-of-gravity calculation.

The pixels used for the center-of-gravity calculation are further narrowed down by performing a processing of extracting only the pixels in a contour part. Of the pixels that have a predetermined parallax value and are located in the region defined by the points LeftX, RightX, TopY and BottomY, only the pixels in top, left and right contour parts (edges) of the region having a width of several pixels are extracted. The region formed by the extracted pixels is generally crescent-shaped.

FIG. 5b is a schematic diagram showing the pixels used for the calculation of the center of gravity of the head and the calculated center of gravity. The coordinate of the center of gravity of the head is calculated based on the coordinate values of the pixels in the contour region (this is the processing of Step S204). The squares in the drawing are conceptual representations of the pixels used for the center-of-gravity calculation, and the black dot at the center represents the calculated center of gravity of the head. When the center of gravity of the head is calculated based on the pixels that lie in a predetermined coordinate range and have a predetermined parallax value, stereo matching is difficult to achieve in the center part of the head, and the parallax data for the center part of the head tends to be erroneous, because the center part of the head is generally covered with hair and is of the same color. Even a precise active range sensor suffers from a problem that the sensor cannot acquire parallax information because of light absorption or the like by waving hair, and there is a problem that a significant amount of parallax data on the center part of the head drops, and the part coordinate calculating section 102 cannot accurately calculate the coordinate of the center of gravity of the head. In this respect, as described above, the pixels used for the center-of-gravity calculation are modified with the coordinates of the centers of gravity of the shoulders, and the center of gravity of the parallax pixels in the contour region of the head is calculated as the coordinate of the center of gravity of the head, thereby enabling accurate and stable extraction of the head part. In acquisition of the parallax and color information for the pixels, there can be no information on a pixel that corresponds to the center of gravity because of no parallax. In that case, camera coordinates of 3 by 3 pixels in the periphery of the center of gravity are also calculated, and an average of the values of the pixels whose camera coordinates can be calculated is calculated as the camera coordinate of the center of gravity.

(2) Processing of Generating Instructor Action Represented by Geometrical Model of User

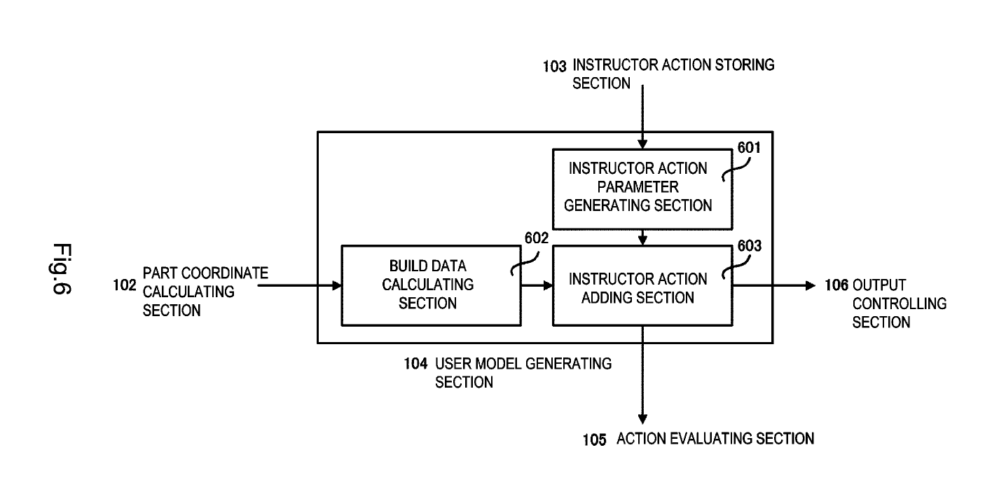

FIG. 6 is a functional block diagram showing an example of a configuration of the user model generating section 104. For example, the user model generating section 104 comprises an instructor action parameter generating section 601, a build data calculating section 602, and an instructor action adding section 603. The instructor action parameter generating section 601 reads the instructor dynamic image data stored in the instructor action storing section 103, and generates an instructor action parameter. The instructor action parameter is a variation value between adjacent image frames of a part coordinate. The instructor action parameter is calculated for each of the x, y and z coordinate values of each part of the body. More specifically, the instructor action parameter is calculated by calculating the part coordinate of each part of the body for each piece of image data of the instructor dynamic image and determining a time-series difference for each part coordinate. If the instructor action parameter is generated in advance and stored in the instructor action storing section 103, the instructor action parameter generating section 601 can be omitted.

In order that build data can be calculated, the build data calculating section 602 instructs the user to keep a posture to perform the chest compression action at such a position in front of the camera that the upper half of the body of the user is contained in the image for a predetermined length of time (for example, 1 to 2 seconds or, in other words, 50 frames on the assumption that one frame lasts for 1/30 seconds). For example, the build data calculating section 602 can instruct the user to keep a posture in which the hands are put on the chest of a cardiopulmonary resuscitation doll put on the floor with the line connecting the midpoint of the line connecting the shoulders and the palms being perpendicular to the floor plane. In that case, the audio output apparatus 20 may provide an audio instruction to keep the posture. Moving image data is acquired while the user is remaining at rest, and build data is calculated based on the moving image data over a predetermined length of time. In this example, based on the part coordinates calculated by the part coordinate calculating section 102 in the part coordinate calculation processing (1) described above, the build data calculating section 602 calculate build data by calculating, for each part, an average of a plurality of part coordinates in a predetermined length of time.

The instructor action adding section 603 generates moving image data on the instructor action that reflects the build of the body of the user by adding the instructor action parameter, which indicates a time-series variation of the coordinate value of the part coordinate, generated by the instructor action parameter generating section 601 to the build data for the user generated by the build data calculating section 602.

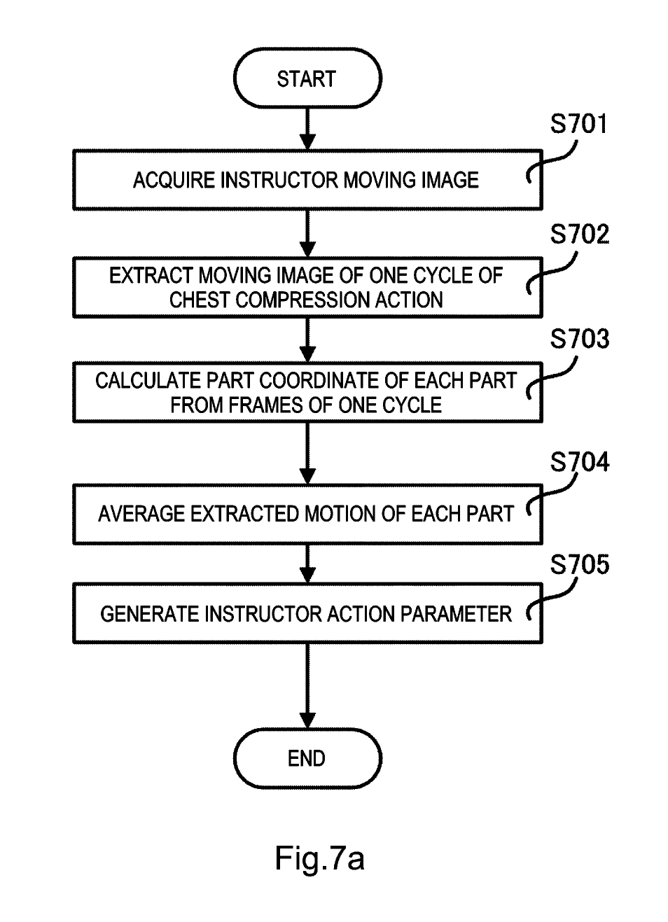

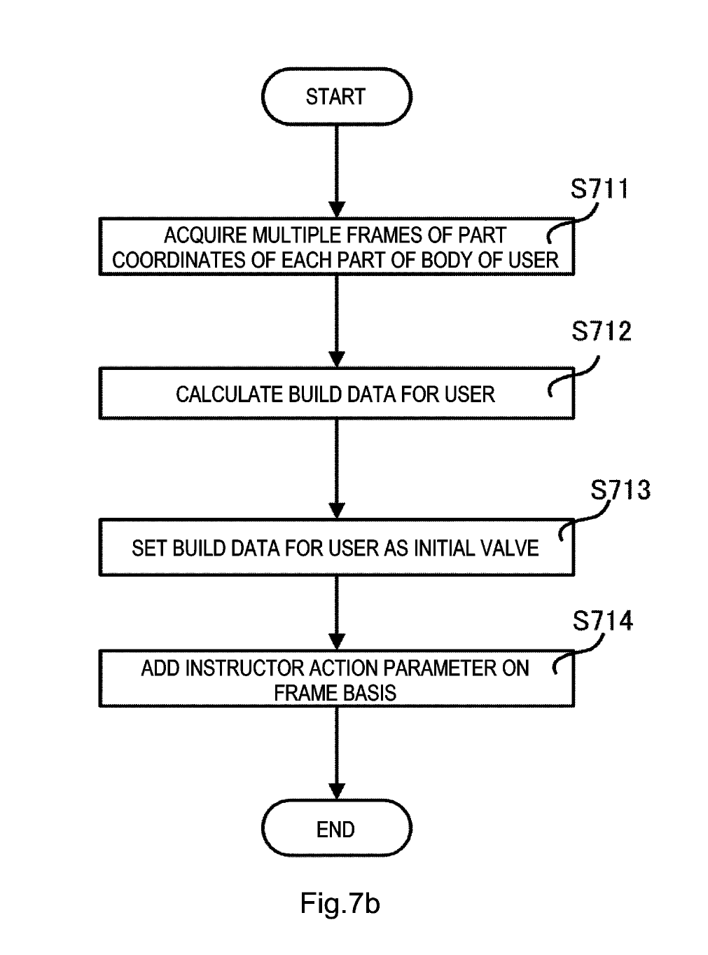

Next, a processing of generating the moving image data on the instructor action represented by the geometric model of the user will be described in detail with reference to flowcharts. FIG. 7a is a flowchart showing a processing of generating an instructor action parameter based on an instructor moving image.

First, the instructor action parameter generating section 601 acquires the instructor moving image data stored in the instructor action storing section 103 (Step S701). The instructor action parameter generating section 601 then extracts moving image data of one cycle of chest compression action (Step S702). For example, moving image data of chest compression by an emergency medical technician is used as the instructor moving image data, and moving image data of one cycle of application of a compression force to the chest and removal of the compression force is extracted. For example, one cycle of chest compression action is extracted by extracting a variation of the coordinate (y coordinate) of the part coordinate of a hand in the direction of compressing the chest of the doll. If the stored moving image data is moving image data of one cycle of chest compression action, this step can be omitted.

The instructor action parameter generating section 601 calculates the part coordinate of each part of the body for each piece of image data of the moving image data of one cycle of chest compression action (Step S703). The method of calculating the part coordinate is the same as the method described above, and the part coordinate of each of the head, the shoulders, the elbows, the hands and the wrists is calculated.

The instructor action parameter generating section 601 takes an average of the movement of the extracted part coordinates (Step S704). The calculated part coordinate data is sorted on a part-coordinate basis, and the time series of the movement is normalized. For example, suppose that there are 7 frames of data on the y coordinate of the head.

TABLE 1

| | FRAME NUMBER | | | | | | |
|---|---|---|---|---|---|---|---|
| | 1 | 2 | 3 | 4 | 5 | 6 | 7 |
| Y COORDINATE | 130 | 140 | 160 | 162 | 140 | 130 | 128 |
| OF HEAD | | | | | | | |

This is normalized as shown below.

TABLE 2

| | tₖ | | | | | | |
|---|---|---|---|---|---|---|---|
| | 0 | 0.16 | 0.33 | 0.5 | 0.67 | 0.83 | 1 |
| Y COORDINATE | 130 | 140 | 160 | 162 | 140 | 130 | 128 |
| OF HEAD | | | | | | | |

Furthermore, polynomial approximation based on the least square method is performed on the part coordinates of each part. The resulting polynomial represents an accurate transition of the corresponding part coordinate in a range of 0≦t≦1 (t denotes time), so that instructor action data, which is data on a time-series variation of the movement, can be generated by substituting a normalized average number of frames of an exemplary action to the polynomial.

The instructor action parameter generating section 601 generates an instructor action parameter that is data on a time-series variation of the movement (Step S705). The generated instructor action parameter is not there-dimensional coordinate data that indicates a position but data that indicates a time-series variation of the coordinate data. That is, the generated instructor action parameter is data on the difference in coordinate value between adjacent frames.

For example, the instructor action parameter for the y coordinate data for the head after the polynomial approximation is as shown below.

TABLE 3

FRAMES

| | 1-2 | 2-3 | 3-4 | 4-5 | 5-6 | 6-7 |
|---|---|---|---|---|---|---|
| DIFFERENCE | 14 | 21 | 1 | −20 | −12 | −3 |

Although Table 3 shows a case of 7 frames, the instructor action parameter for the part coordinate of each part is generated over the length of time of one cycle of chest compression action.

The instructor action parameter, which is data on a time-series variation of the movement, may be generated in advance. In that case, the generation processing to be performed by the instructor action parameter generating section 601 is performed in advance, data on the instructor action parameter, which is data on a time-series variation of the movement in one cycle, is stored in the instructor action storing section 103, and the instructor action adding section 603 reads the instructor action parameter from the instructor action storing section 103 and performs the addition processing.

FIG. 7b is a flowchart showing a processing of generating a moving image of an instructor action represented by a geometric model of a user. The build data calculating section 602 acoustically or visually instructs the user to remain at rest at a predetermined position where the upper half of the body of the user is imaged by the imaging apparatus for a predetermined length of time (for example, 2 to 3 seconds or so), and acquires part coordinates of each part of the body of the user of a plurality of frames (Step S711). The part coordinate of each part is calculated for each piece of image data by the part coordinate calculating section 102 and input to the build data calculating section 602. Therefore, the build data calculating section 602 stores a plurality of frames (50 frames, for example) of part coordinate data input thereto.

The build data calculating section 602 calculates, as the build data for the user, an average value of the plurality of frames of part coordinate data stored therein for each part (Step S712). The instructor action adding section 603 acquires the build data from the build data calculating section 602, and sets the part coordinate data as an initial value of the build data (Step S713). In principle, a geometric model of initial values of the user is generated based on the calculated build data. A correction processing for the part coordinates of the elbows and the shoulders, which is performed by the instructor action adding section 603, will be described later.

Although an average value of part coordinate data of each part at rest is calculated to calculate the build data in this example, the part coordinate of the hand may be calculated after several chest compression actions are performed for a try. In that case, three-dimensional shape data for the chest of the cardiopulmonary resuscitation doll is acquired before imaging the user. More specifically, the part coordinate calculating section 102 acquires a data sequence of coordinates of a ridge part of the chest of the cardiopulmonary resuscitation doll. The action evaluating apparatus 100 then acoustically or otherwise instructs the user to put the hands on the cardiopulmonary resuscitation doll and perform a plurality of chest compression actions, which involve compressing and releasing the chest. The build data calculating section 602 calculates the highest position (position at which the y coordinate is at the maximum value) of the hands moving in this action, that is, the values (x, y) of the coordinate of the center of gravity of the hands that are not compressing the chest. This value of x is adopted as the x coordinate value for the part coordinate data for the hands. The value of y of the ridge part of the chest of the doll at the time when this x coordinate value is achieved is acquired and compared with the y coordinate value of the hands, and the greater value of y is adopted as the y coordinate value of the part coordinate data for the hands. In this way, the position of the hands that are not compressing the chest is adopted as an initial position. Since the part coordinate of the hands is calculated as described above, the initial position of the hands can be accurately set, and precise action evaluation can be achieved.

The build data for the user calculated by the build data calculating section 602 and the instructor action parameter generated by the instructor action parameter generating section 601 are input to the instructor action adding section 603. At each point in time (for each frame image), the instructor action adding section 603 adds the instructor action parameter to the initial value, that is, the build data for the user calculated by the build data calculating section 602 (Step S714). That is, the instructor action parameter, which is data that indicates a time-series variation of the coordinate of each part, is added to the build data for the user, and then added to the resulting coordinate value, so that the part coordinate of the user varies with the instructor action. In this way, moving image data on the instructor action that reflects the build of the user can be generated.

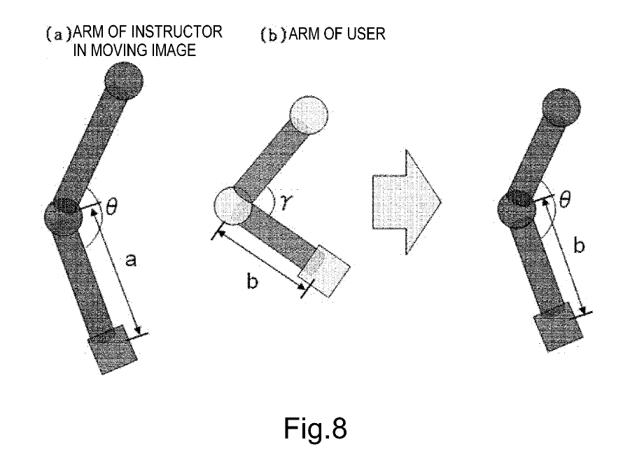

However, if the initial posture of the user is improper when the instructor action parameter is generated using the build data for the user as it is, a problem can arise that an erroneous instructor action is exhibited. FIG. 8 is a schematic diagram for illustrating correction of the build data for the user. As shown in Part (a) of FIG. 8, in the chest compression action, in particular, the arms initially extend relatively straight in the proper position. However, the arms of the user may be initially bent as shown in Part (b) of FIG. 8. In this respect, the instructor action adding section 603 makes a correction on the build data for the elbows and the shoulders with reference to the build data for the wrists.

The instructor action adding section 603 acquires, as the part coordinate data, the initial values of the wrists, the elbows and the shoulders at the time when the instructor action parameter is generated from the instructor action parameter generating section 601, and calculates an initial angle θ determined by the positions of the wrist, the elbow and the shoulder. The initial angle θ may be calculated in advance and stored.

The instructor action adding section 603 acquires the build data from the build data calculating section 602, and calculates the length of the part of each arm from the wrist to the elbow from the part coordinates of the wrists and the elbows of the user. Similarly, the instructor action adding section 603 calculates the length of the part of each arm from the elbow to the shoulder from the part coordinates of the elbow and the shoulder of the user. Based on the part coordinates of the wrists of the build data, the initial angle θ of the instructor action, the calculated lengths from the wrists to the elbows, and the calculated lengths from the elbows to the shoulders, the instructor action adding section 603 calculates the part coordinates of the elbows and the shoulders of the user whose arms form the initial angle θ with respect to the part coordinates of the wrists, and corrects the part coordinates of the elbows and the shoulders of the build data.

In this way, the part coordinates of the elbows and the part coordinates of the shoulders of the build data are replaced with coordinate data for the proper initial posture. Therefore, the initial posture that reflects the build of the user can be exhibited.

(3) Processing of Displaying Action of User and Instructor Action in Superimposed Manner and Evaluating Action of User

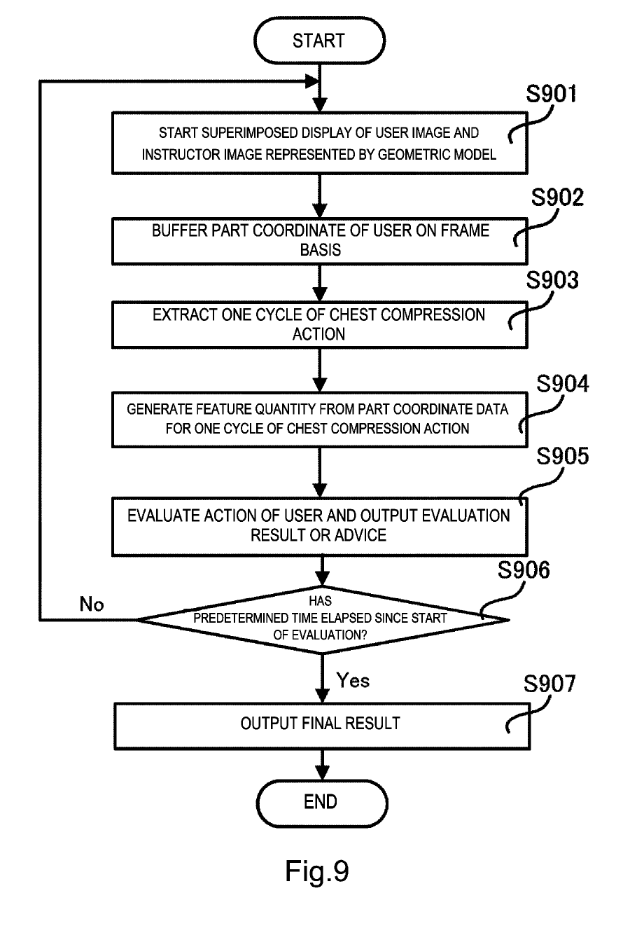

Once calculation of the build data is completed, the instructor action represented by the model of the user becomes able to be displayed, and the process proceeds to action learning (action evaluation mode). When the user is performing the action, the instructor action represented by the model of the user is displayed in a superimposed manner, and the action of the user is evaluated. FIG. 9 is a flowchart showing a processing of evaluating the action of the user.

First, under the output control of the output controlling section 106, the corrected geometric model of the instructor action in the initial position that reflects the build of the user generated by the user model generating section 104 is displayed on the display apparatus 30, and superimposed display of the geometric model and the image of the user taken by the imaging apparatus is started (Step S901). Once the geometric model is displayed, the user adjust the posture so that the geometric model and the image of the user coincide with each other.

When the action evaluating apparatus 100 visually or acoustically instructs the user to start action learning, the user starts the chest compression action, and action evaluation concurrently starts. While the action evaluation is being performed, the geometric model is displayed in a superimposed manner. The action evaluating section 105 buffers the part coordinates of each part of the body of the user calculated for each piece of image data by the part coordinate calculating section 102 on a frame image basis (Step S902). Each piece of buffered part coordinate data is used for detection of one cycle of chest compression action or calculation of feature quantities in the action evaluation.

The action evaluating section 105 extracts one cycle of chest compression action (Step S903). The transition of the part coordinates of the hands of the user performing the chest compression action on the cardiopulmonary resuscitation doll is buffered and checked. In particular, of the movements of the part coordinates of the hands of the user, a movement of the coordinate (y coordinate) in the direction of compressing the cardiopulmonary resuscitation doll that indicates a compression (for example, a group of frames over which the value of the y coordinate continuously decreases) and a movement of the same that indicates a retrieval of the hand (for example, a group of frames over which the value of the y coordinate continuously increases) are extracted as one cycle of chest compression action. A hand movement the variation of the coordinate value of which is equal to or less than a predetermined value is regarded as being invalid. A method of extracting one cycle of chest compression action will be described in detail later.

Once one cycle of chest compression action is extracted, the action evaluating section 105 generates feature quantities used for evaluating the action of the user or providing an advice based on the part coordinate data for one cycle (Step S904). The feature quantities include the time (number of frames) required for one cycle of the chest compression action and an average of the minimum value of the left elbow angle and the right elbow angle in one cycle, for example. The action evaluating section 105 stores the feature quantities used for the evaluation in association with thresholds of the feature quantities and evaluations in the form of an evaluation table.

The action evaluating section 105 refers to the evaluation table for the generated feature quantities and compares the generated feature quantities with the respective predetermined thresholds stored therein, thereby evaluating the action of the user (Step S905). The action evaluating section 105 compares each feature quantity with a threshold and extracts any feature quantity that does not satisfy the threshold criterion. The action evaluation is performed for each cycle. The evaluation result and any advice are acoustically or visually output for each cycle under the output control of the output controlling section 106.

The action evaluating section 105 detects whether a certain length of time has elapsed from the start of the evaluation or not (Step S906). If the certain length of time has not elapsed (No in Step S906), the evaluation continues. The certain length of time is 2 minutes, which is prescribed as a guideline for the duration of a continuous chest compression action of one person, for example. However, the certain length of time is not limited to this value and can be arbitrarily set. If the certain length of time has elapsed (Yes in Step S906), a final evaluation result is output (Step S907).

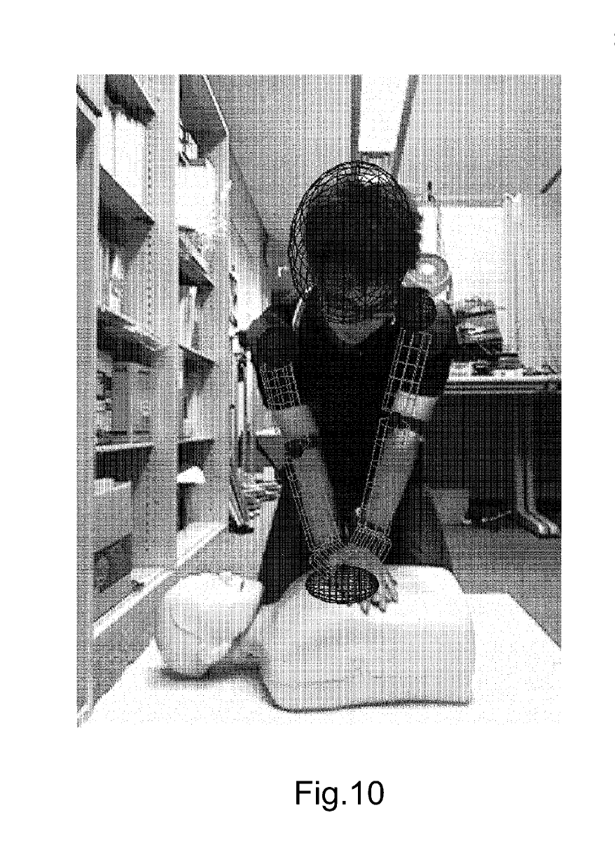

FIG. 10 shows an example of the superimposed display of the geometric model image that reflects the build of the user and the image of the user. Once the instructor action adding section 603 generates a geometric model of the user based on the part coordinate of each part of the body, the moving image data on the geometric model of the instructor action is displayed in the form of a mesh geometric model as shown in FIG. 10. The geometric model based on the part coordinate of the center of gravity of the body is generated according to prior art, and therefore, description thereof will be omitted.

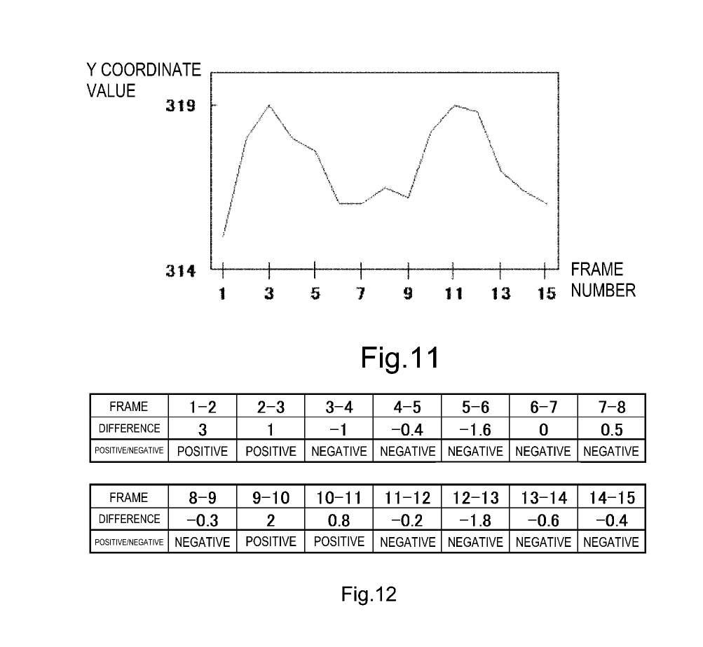

Next, a method of extracting one cycle of chest compression action in Step S903 in FIG. 9 will be described. FIG. 11 is a graph showing a transition of the part coordinate of the hands of the user buffered in Step 5902 in FIG. 9. The “Y coordinate” is the y coordinate in the camera coordinate system and is in the vertical direction. In other words, the y coordinate is in the direction of the hands of the user compressing and releasing the chest of the doll, and a variation of the coordinate value of the y coordinate of the part coordinates is extracted. The action evaluating section 105 extracts a variation (difference) in coordinate between pieces of image data.

FIG. 12 is a table showing the difference of the coordinate value between pieces of image data (image data frames) and the sign (positive or negative) of the direction of movement of the hands. For example, the variation between the frames 7 and 8 is a positive value, while the sign of the direction of movement of the hands for the frames 7 and 8 is negative. In such a case, the action evaluating section 105 regards the movement between the frames 7 and 8 as being invalid and changes the movement to “negative”. In this way, if the sign of the direction of movement between adjacent frames differs from the sign of the difference of the coordinate value between the frames, a processing of invalidating the movement is performed.

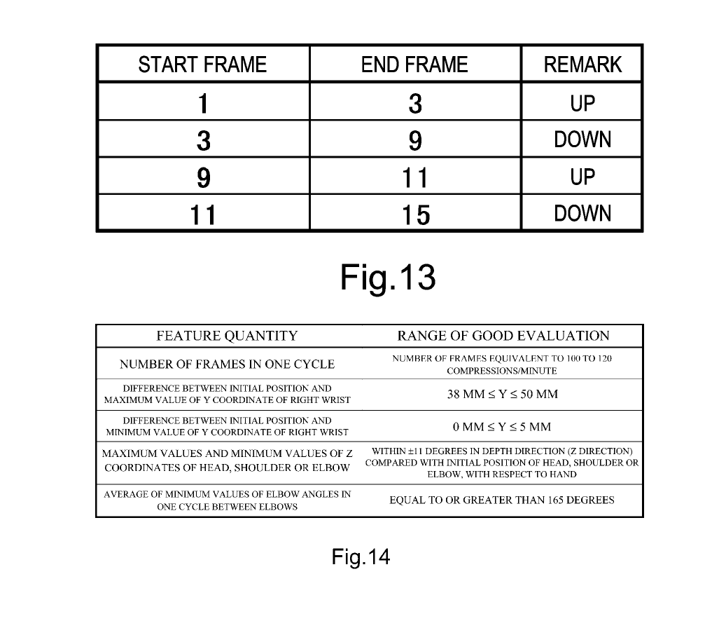

FIG. 13 is an example of a table showing one cycle of chest compression action detected based on the transition of the part coordinate of the hands of the user. If the variation in coordinate value between frames is “positive”, the movement of the hands of the user during the frames is regarded as a movement away from the doll or an upward movement, that is, a movement of retrieving from the chest. If the variation in coordinate value between frames is “negative”, the movement of the hands of the user during the frames is regarded as a movement toward the doll or a downward movement, that is, a movement of compressing the chest. The action evaluating section 105 extracts one cycle of chest compression action involving the compression and the retrieval.

FIG. 14 is an example of an evaluation table that contains feature quantities generated in Step S904 in FIG. 9 and thresholds thereof. Thresholds for desired actions are stored in association with the feature quantities, and the action evaluating section 105 evaluates each feature quantity for one cycle of chest compression action based on the evaluation table in Step S905. For example, if the difference between the initial position of the y coordinate of the right wrist and the maximum value is 40, the chest compression action is determined as good. In the evaluation table, maximum values and minimum values of the z coordinates of the head, the shoulders and the elbows are set as feature quantities for evaluation. Since the user is positioned in front of the camera, the z direction is the depth direction. Whether the user is in the proper posture during the chest compression action or not can be evaluated by checking the shifts in the z direction of the head, the shoulders and the elbows from the initial posture. Furthermore, whether the user is performing the chest compression action with the arms being kept straight can be evaluated by checking whether the elbow angle is equal to or greater than 165 degrees or not. Whether the user is performing the chest compression action in the proper posture or not can be evaluated through these evaluations.

Although the evaluation table stores only the thresholds in this example, advices can also be stored in the evaluation table in association with the thresholds. For example, an advice “slow down the pace” in the case where the number of frames in one cycle is less than 6 or an advice “quicken the pace” in the case where the number of frames in one cycle is 8 or more may be stored. The evaluation and the advice are visually or acoustically output.

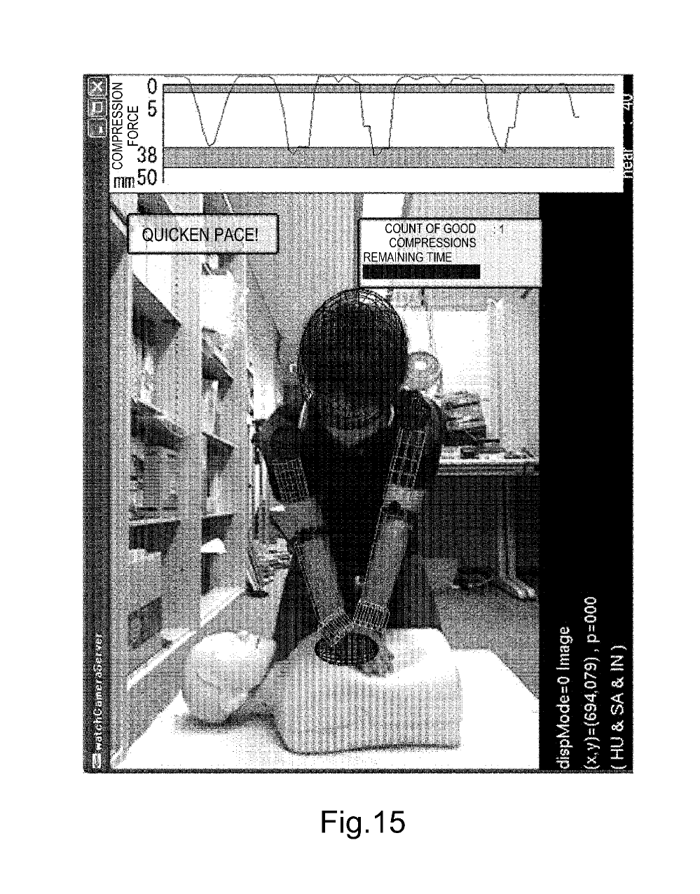

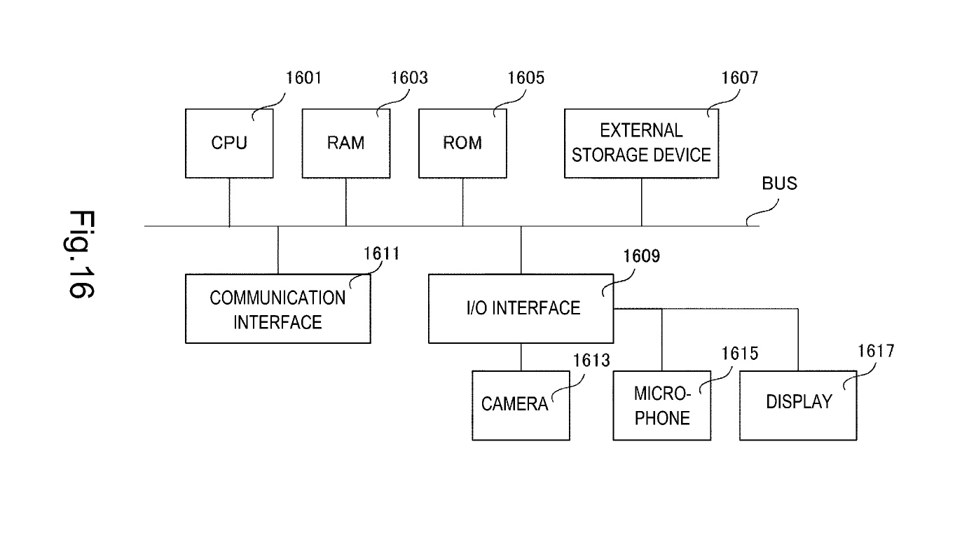

FIG. 15 shows an example of a superimposed display of the moving image data on the geometric model of the user performing the instructor action and the moving image data on the chest compression action of the user in which an advice is further displayed on the screen. If all the feature quantities in a cycle of chest compression action fall within the respective threshold ranges, the action evaluating section 105 evaluates the action as an exemplary action. As shown in FIG. 15, exemplary actions can be counted as “good”, and the count can be displayed. Furthermore, as shown in FIG. 15, the depth to which the hands of the user compress the chest of the doll, that is, the transition of the y coordinate of the hands, may be displayed along with a threshold line that indicates the required depth of chest compression so that whether the chest is being compressed with an adequate force or not can be seen at a glance.

As shown in FIG. 16, the action evaluating apparatus 100 may be formed by a personal computer of a system user and a program running on the personal computer. The personal computer comprises a central processing unit (CPU) 1601 and a random access memory (RAM) 1603, a read only memory (ROM) 1605, an external storage device 1607 such as a hard disk drive, an I/O interface 1609 and a communication interface 1611 for connecting to a communication network line, which are connected to the CPU 1601 via a bus, for example, and a camera 1613, a microphone 1615 and a display 1617 are connected to the interface 1609. In this case, for example, the functions of the image acquiring section 101, the part coordinate calculating section 102, the user model generating section 104, the action evaluating section 105 and the output controlling section 106 are implemented by a program running on the personal computer, the function of the instructor action storing section 103 is implemented by the external storage device, and the functions of the imaging apparatus 10, the audio output apparatus 20 and the display apparatus 30 are implemented by the camera, the microphone and the display, respectively. The program that implements the various functions is stored in the external storage device 1607, loaded into the RAM 1603 and then executed by the CPU 1601.

### REFERENCE SIGNS LIST

10 Imaging Apparatus
20 Audio Output Apparatus
30 Display Apparatus
100 Action Evaluating Apparatus
101 Image Acquiring Section
102 Part Coordinate Calculating Section
103 Instructor Action Storing Section
104 User Model Generating Section
105 Action Evaluating Section
106 Output Controlling Section

1. An action evaluating apparatus comprising:
a part coordinate calculating section that calculates a part coordinate of a body of a user based on image data on the user;
a user model generating section that generates a geometric model of the user based on the part coordinate and generates moving image data on an instructor action represented by the geometric model of the user based on an instructor action parameter;
an action evaluating section that evaluates an action of the user based on the part coordinate; and
an output controlling section that displays the instructor action represented by the geometric model of the user and the action of the user in a superimposed manner and outputs an evaluation result.

2. The action evaluating apparatus according to claim 1, wherein the part coordinate calculating section calculates a part coordinate of each of parts of the body of the user including the head, the shoulders, the elbows, the hands and the wrists by calculating a coordinate of the center of gravity of the part.

3. The action evaluating apparatus according to claim 1, wherein the part coordinate calculating section calculates the part coordinate of each part based on at least parallax information for a pixel in a predetermined region of the part.

4. The action evaluating apparatus according to claim 2, wherein the part coordinate calculating section calculates part coordinates of the shoulders and calculates a part coordinate of the head based on the part coordinates of the shoulders.

5. The action evaluating apparatus according to claim 1, wherein the user model generating part has:
a build data calculating section that generates build data of the user based on the part coordinates calculated by the part coordinate calculating section; and
an instructor action adding section that generates instructor moving image data represented by the geometric model of the user by adding an instructor action parameter to the build data for the user at each point in time.

6. The action evaluating apparatus according to claim 5, wherein the instructor action adding section corrects the part coordinates of the elbows and the shoulders of the build data acquired from the build data calculating section based on the part coordinates of the wrists and an initial angle involved with the instructor action.

7. The action evaluating apparatus according to claim 1, wherein the action evaluating section extracts one cycle of action of the user for evaluation, and
the output controlling section outputs an evaluation result.

8. The action evaluating apparatus according to claim 1, wherein the action is a chest compression action, and the action evaluating apparatus evaluates the chest compression action of the user.

9. A program that makes a computer function as an action evaluating apparatus that comprises:
a part coordinate calculating section that calculates a part coordinate of a body of a user based on image data on the user;
a user model generating section that generates a geometric model of the user based on the part coordinate and generates moving image data on an instructor action represented by the geometric model of the user based on an instructor action parameter;
an action evaluating section that evaluates an action of the user based on the part coordinate; and
an output controlling section that displays the instructor action represented by the geometric model of the user and the action of the user in a superimposed manner and outputs an evaluation result.
